(19) United States
(12) Patent Application Publication
(10) Pub. No.: US 2025/0155675 A1
(43) Pub. Date: May 15, 2025

(54) IMAGING LENS SYSTEM, CAMERA MODULE, IN-VEHICLE SYSTEM, AND VEHICLE

(71) Applicant: Maxell, Ltd., Kyoto (JP)

(72) Inventor: Yukihiro SHIMOEDA, Otokuni-gun, Kyoto (JP)

(73) Assignee: Maxell, Ltd., Kyoto (JP)

(21) Appl. No.: 18/728,486

(22) PCT Filed: Jan. 6, 2023
(86) PCT No.: PCT/JP2023/000159

§ 371 Date: Jul. 12, 2024

(30) Foreign Application Priority Data
Jan. 14, 2022 (JP) 2022-004493

(51) Int. Cl. G02B 9/62; G02B 13/18; G03B 30/00

(52) U.S. Cl. CPC G02B 9/62; G02B 13/18; G03B 30/00

(57) ABSTRACT

An imaging lens system includes, sequentially from an object side: a first lens having positive power with an object-side surface whose convex surface faces the object side; a second lens having negative power with an object-side surface whose convex surface faces the object side; a third lens, the third lens being a meniscus lens having positive power with an image-side surface whose convex surface faces an image side; a fourth lens having negative power with an image-side surface whose concave surface faces the image side; a fifth lens which is a biconvex lens having positive power; and a sixth lens with an object-side surface whose convex surface faces the object side, in which the imaging lens system satisfies the following Conditional Expressions (1) to (3): nd1>1.77 . . . (1), nd2>1.77 . . . (2), and 0.8<f3/f<12.0 . . . (3).

### TECHNICAL FIELD

The present invention relates to an imaging lens system, a camera module, an in-vehicle system, and a vehicle.

### BACKGROUND ART

In recent years, in an on-board camera mounted on a car, a capturing element has a high resolution, and good optical performance in which various A kinds of aberrations are few is also required for an imaging lens system. capability of detecting a person or an object has been added to the on-board camera, and since such an on-board camera uses the detection capability in both daytime and nighttime, a bright imaging lens system with a small f-number is required at the same time.

For example, Patent Literature 1 describes an imaging lens system to be mounted on a monitoring camera or an on-board camera, the imaging lens system being a bright imaging lens system made of seven lenses in which an f-number is 1.4.

Patent Literature 2 describes an imaging lens system to be mounted on a monitoring camera or the like, the imaging lens system being an imaging lens system made of six lenses in which an f-number is 2.88.

Patent Literature 3 describes an imaging lens system to be mounted on a monitoring camera or an on-board camera, the imaging lens system being an imaging lens system made of six lenses in which an f-number is 2.28.

### CITATION LIST

### Patent Literature

Patent Literature 1: Japanese Unexamined Patent Application Publication No. 2012-220741

Patent Literature 2: Japanese Unexamined Patent Application Publication No. 2015-111192

Patent Literature 3: Japanese Unexamined Patent Application Publication No. 2017-102183

### SUMMARY OF INVENTION

### Technical Problem

However, the imaging lens system described in Patent Literature 1 has a problem that since it is made of seven lenses, the cost is high. The imaging lens systems described in Patent Literatures 2 and 3 have large f-numbers, which are not bright enough, resulting in longer detection times for sensors and an inability to meet the requirements for instantaneous sensing capabilities required for autonomous driving or the like.

The present invention has been made in view of such problems, and an object of the present invention is to provide an imaging lens system, a camera module, an in-vehicle system, and a vehicle which have sufficient brightness with reduced cost.

### Solution to Problem

An imaging lens system according to an embodiment includes, sequentially from an object side toward an image side: a first lens having positive power with an object-side surface whose convex surface faces the object side; a second lens having negative power with an object-side surface whose convex surface faces the object side; a third lens, the third lens being a meniscus lens having positive power with an image-side surface whose convex surface faces the image side; a fourth lens having negative power with an image-side surface whose concave surface faces the image side; a fifth lens which is a biconvex lens having positive power; and a sixth lens with an object-side surface whose convex surface faces the object side, in which the imaging lens system satisfies the following Conditional Expressions (1) to (3):

nd1>1.77 (1),

nd2>1.77 (2), and

0.8<f3/f<12.0 (3)
where nd1 is defined as a d-line refractive index of the first lens, nd2 is defined as a d-line refractive index of the second lens, f3 is defined as a focal length of the third lens, and f is defined as a focal length of an entire optical system.

### Advantageous Effects of Invention

According to the present invention, it is possible to provide an imaging lens system, a camera module, an in-vehicle system, and a vehicle which have sufficient brightness with reduced cost.

### BRIEF DESCRIPTION OF DRAWINGS

FIG. 1 is a cross-sectional view showing a configuration of a camera module and an imaging lens system according to Example 1;

FIG. 2A is a spherical aberration diagram (longitudinal aberration diagram) of the imaging lens system according to Example 1;

FIG. 2B is a field curvature diagram of the imaging lens system according to Example 1;

FIG. 2C is a distortion diagram of the imaging lens system according to Example 1;

FIG. 2D is a lateral color aberration of the imaging lens system according to Example 1;

FIG. 3 is a cross-sectional view showing a configuration of a camera module and an imaging lens system according to Example 2;

FIG. 4A is a spherical aberration diagram (longitudinal aberration diagram) of the imaging lens system according to Example 2;

FIG. 4B is a field curvature diagram of the imaging lens system according to Example 2;

FIG. 4C is a distortion diagram of the imaging lens system according to Example 2;

FIG. 4D is a lateral color aberration of the imaging lens system according to Example 2;

FIG. 5 is a cross-sectional view showing a configuration of a camera module and an imaging lens system according to Example 3;

FIG. 6A is a spherical aberration diagram (longitudinal aberration diagram) of the imaging lens system according to Example 3;

FIG. 6B is a field curvature diagram of the imaging lens system according to Example 3;

FIG. 6C is a distortion diagram of the imaging lens system according to Example 3;

FIG. 6D is a lateral color aberration of the imaging lens system according to Example 3;

FIG. 7 is a cross-sectional view showing a configuration of a camera module and an imaging lens system according to Example 4;

FIG. 8A is a spherical aberration diagram (longitudinal aberration diagram) of the imaging lens system according to Example 4;

FIG. 8B is a field curvature diagram of the imaging lens system according to Example 4;

FIG. 8C is a distortion diagram of the imaging lens system according to Example 4;

FIG. 8D is a lateral color aberration of the imaging lens system according to Example 4;

FIG. 9 is a cross-sectional view showing a configuration of a camera module and an imaging lens system according to Example 5;

FIG. 10A is a spherical aberration diagram (longitudinal aberration diagram) of the imaging lens system according to Example 5;

FIG. 10B is a field curvature diagram of the imaging lens system according to Example 5;

FIG. 10C is a distortion diagram of the imaging lens system according to Example 5;

FIG. 10D is a lateral color aberration of the imaging lens system according to Example 5;

FIG. 11 is a cross-sectional view showing a configuration of a camera module and an imaging lens system according to Example 6;

FIG. 12A is a spherical aberration diagram (longitudinal aberration diagram) of the imaging lens system according to Example 6;

FIG. 12B is a field curvature diagram of the imaging lens system according to Example 6;

FIG. 12C is a distortion diagram of the imaging lens system according to Example 6;

FIG. 12D is a lateral color aberration of the imaging lens system according to Example 6;

FIG. 13 is an overview diagram of a car including an in-vehicle system with a camera module according to an embodiment of the present invention; and

FIG. 14 is a block diagram showing a configuration of a capturing apparatus constituting the in-vehicle system of FIG. 13.

### DESCRIPTION OF EMBODIMENTS

An embodiment of the present invention will be described below with reference to the drawings. In this embodiment, a highly reliable system can be implemented, especially in a sensing system, and contributes to the development of a resilient infrastructure. The target of this embodiment is “9. Build resilient infrastructure, promote inclusive and sustainable industrialization and foster innovation” of the United Nations Sustainable Development Goals (SDGs), “9.1 Develop quality, reliable, sustainable and resilient infrastructure, including regional and transborder infrastructure, to support economic development and human well-being, with a focus on affordable and equitable access for all”.

### First Embodiment: Imaging Lens System

An imaging lens system according to a first embodiment includes, sequentially from an object side toward an image side: a first lens having positive power with an object-side surface whose convex surface faces the object side; a second lens having negative power with an object-side surface whose convex surface faces the object side; a third lens, the third lens being a meniscus lens having positive power with an image-side surface whose convex surface faces the image side; a fourth lens having negative power with an image-side surface whose concave surface faces the image side; a fifth lens which is a biconvex lens having positive power; and a sixth lens with an object-side surface whose convex surface faces the object side.

The imaging lens system according to the first embodiment satisfies the following Conditional Expressions (1) to (3):

nd1>1.77 (1),

nd2>1.77 (2), and

0.8<f3/f<12.0 (3)
where nd1 is defined as a d-line refractive index of the first lens, nd2 is defined as a d-line refractive index of the second lens, f3 is defined as a focal length of the third lens, and f is defined as a focal length of an entire optical system.

Thus, it is possible to provide the imaging lens system having sufficient brightness with reduced cost.

Specifically, by applying a glass material having a high refractive index to the first lens and the second lens, power of the first lens and the second lens can be made strong, and distortions and field curvatures can be corrected. Therefore, it becomes possible to take more light into the imaging lens system.

Accordingly, the imaging lens system which has a sufficiently high resolution and is sufficiently bright can be achieved.

By controlling the focal length of the third lens to a predetermined range with respect to the focal length of the entire optical system, power of the third lens can be set to an optimal range with respect to power of the entire optical system, and distortions and field curvatures can be corrected. Thus, it becomes possible to take more light into the imaging lens system. Accordingly, the imaging lens system which has a sufficiently high resolution and is sufficiently bright can be achieved.

The imaging lens system can be constituted of six lenses, and the cost can be reduced. Therefore, it is possible to provide the imaging lens system and a camera module having sufficient brightness with reduced cost.

More specifically, by satisfying the above Conditional Expression (1), the positive power of the first lens can be made strong, and various aberrations such as distortions and field curvatures can be corrected. In other words, if the d-line refractive index nd1 of the first lens is 1.77 or less, various aberrations such as distortions and field curvatures cannot be sufficiently corrected, and the imaging lens system having sufficient brightness cannot be achieved. The d-line refractive index nd1 of the first lens is preferably 1.80 or greater, more preferably 1.83 or greater, and optimally 1.86 or greater.

By satisfying the above Conditional Expression (2), the negative power of the second lens can be made strong, and various aberrations such as distortions and field curvatures can be corrected. In other words, if the d-line refractive index nd2 of the second lens is 1.77 or less, various aberrations such as distortions and field curvatures cannot be sufficiently corrected, and the imaging lens system having sufficient brightness cannot be achieved. The d-line refractive index nd2 of the second lens is preferably 1.80 or greater, more preferably 1.83 or greater, and optimally 1.86 or greater.

By satisfying the Conditional Expression (3), the power of the third lens with respect to the power of the entire optical system can be set to an optimal range, and various aberrations such as distortions and field curvatures can be corrected. If f3/f is 12.0 or more, various aberrations such as distortions and field curvatures cannot be sufficiently corrected, and the imaging lens system having sufficient brightness cannot be achieved. On the other hand, if f3/f is 0.8 or less, various aberrations such as distortions and field curvatures will be excessively corrected and a resolution of the imaging lens system will be reduced, and thus the imaging lens system having sufficient brightness cannot be achieved. The value of f3/f is preferably 1.0 or greater, more preferably 1.4 or greater, and optimally 1.5 or greater. The value of f3/f is preferably 10.1 or smaller, more preferably 9.3 or smaller, and optimally 4.4 or smaller.

When vd4 is defined as an Abbe's number of the fourth lens, the following Conditional Expression (4) is preferably satisfied.

vd4<24 (4)

By satisfying the above Conditional Expression (2), color aberrations on the axis can be corrected. Thus, it becomes possible to take more light into the imaging lens system. Accordingly, the imaging lens system which has a sufficiently high resolution and is sufficiently bright can be achieved. vd4 is more preferably 18 or smaller.

The object-side surface and the image-side surface of the third lens preferably have aspherical surface shapes, and the object-side surface and the image-side surface of the sixth lens preferably have aspherical surface shapes.

With the object-side surface and the image-side surface of the third lens having the aspherical surface shapes, chief aberrations can be effectively corrected, and the imaging lens system having a high resolution can be implemented.

With the object-side surface and the image-side surface of the sixth lens having the aspherical surface shapes, chief aberrations can be effectively corrected, and the imaging lens system having a high resolution can be implemented.

When f6 is defined as a focal length of the sixth lens, the following Conditional Expression (5) is preferably satisfied.

|f6/f|>3.5 (5)

By satisfying the above Conditional Expression (5), field curvatures can be corrected, and the imaging lens system having a high resolution can be implemented. Specifically, if the value of |f6/f| is 3.5 or less, the power of the sixth lens becomes too strong, and various aberrations such as field curvatures will be excessively corrected and a resolution of the imaging lens system will be reduced, and thus the imaging lens system having sufficient brightness cannot be achieved. The value of |f6/f| is more preferably 3.8 or more.

When dNd5/dt is defined as a temperature coefficient of a relative refractive index in the d-line of the fifth lens, the following Conditional Expression (6) is preferably satisfied in a range of 20° C. or higher and 40° C. or lower.

dNd5/dt(×10−6/° C.)<0 (6)

By satisfying the Conditional Expression (6), a shift of a focal length fin the entire imaging lens system due to a temperature change can be suppressed.

In other words, by selecting a glass material in which the temperature coefficient dNd5/dt of the relative refractive index is less than 0 as a material of the fifth lens, a shift of the focal length f in the entire imaging lens system due to a temperature change can be corrected. Specifically, if the value of dNd5/dt satisfies the above Conditional Expression (6), a focus shift range due to a temperature change of the fifth lens itself can offset a difference between a linear expansion coefficient of a barrel and a linear expansion coefficient of a holder holding the lenses of the imaging lens system, and a change (focus shift range) in a distance from the lens surface of the first lens on the object side to a focal plane of the capturing element due to the temperature change. Thus, with the fifth lens, a shift of the focal length f in the entire imaging lens system due to a temperature change can be corrected. dNd5/dt is more preferably less than −0.5, and optimally less than −2.0.

An iris is preferably arranged between the third lens and the fourth lens. By arranging the iris between the third lens and the fourth lens, an optimal aberration correction can be made. If the iris is arranged between the second lens and the third lens, the front lens group would be constituted of two lenses, and various aberrations such as transverse aberrations and field curvatures cannot be sufficiently corrected, and it becomes difficult to implement the imaging lens system having sufficient brightness with a sufficiently small f-number. If the iris is arranged between the fifth lens and the sixth lens, the rear lens group would be constituted of one lens, and various aberrations such as transverse aberrations and field curvatures cannot be sufficiently corrected, and it becomes difficult to implement the imaging lens system having sufficient brightness with a sufficiently small f-number.

The fourth lens and the fifth lens preferably constitute a cemented lens. By constituting a cemented lens with the fourth lens and the fifth lens, the cemented lens enables corrections of color aberrations such as color aberrations on the axis and lateral color aberrations. Thus, the imaging lens system which has a sufficiently high resolution and is sufficiently bright can be achieved.

When f45 is defined as a focal length of the cemented lens constituted of the fourth lens and the fifth lens, the following Conditional Expression (7) is preferably satisfied.

1.2<f45/f<2.2 (7)

By satisfying the above Conditional Expression (7), color aberrations such as color aberrations on the axis and lateral color aberrations can be corrected, and the imaging lens system which has a sufficiently high resolution and is sufficiently bright can be achieved. Specifically, if the value of f45/f is 2.2 or more, positive power of the cemented lens becomes too weak, and color aberrations cannot be sufficiently corrected. On the other hand, if the value of f45/f is 1.2 or less, the positive power of the cemented lens becomes too strong, and color aberrations would be excessively corrected. The value of f45/f is preferably 1.25 or more, more preferably 1.30 or more, and optimally 1.35 or greater. The value of f45/f is preferably 2.10 or less, more preferably 1.64 or less, and optimally 1.56 or less.

The first lens L1 to the sixth lens L6 may be formed of glass. Note that the second lens L2 to the sixth lens L6 may be formed of plastic.

### Second Embodiment: Camera Module

A camera module according to a second embodiment includes the imaging lens system described above and a capturing element arranged at a focal position of the imaging lens system, the capturing element converting light converged through the imaging lens system into an electrical signal. Thus, the camera module having sufficient brightness with reduced cost can be provided.

Next, examples of the imaging lens system according to the first embodiment and the camera module according to the second embodiment will be described with reference to the drawings.

### Example 1

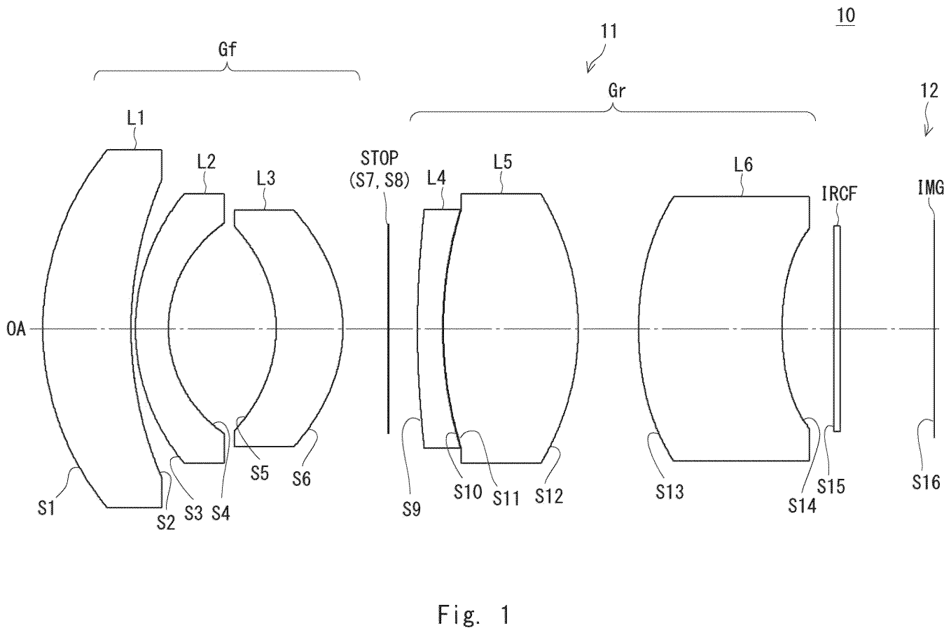

FIG. 1 is a cross-sectional view showing a configuration of a camera module 10 according to Example 1. Specifically, the camera module 10 includes an imaging lens system 11 and a capturing element 12. The imaging lens system 11 and the capturing element 12 are housed in a lens barrel (not shown).

The capturing element 12 is an element for converting received light into an electrical signal, and for example, a CCD image sensor or a CMOS image sensor is used. The capturing element 12 is arranged at an imaging position (focal position) of the imaging lens system 11.

The imaging lens system 11 according to Example 1 is composed of, sequentially from the object side toward the image side, a front lens group Gf composed of a first lens L1, a second lens L2, and a third lens L3, an aperture iris (STOP), and a rear lens group Gr composed of a fourth lens L4, a fifth lens L5, and a sixth lens L6. A focal plane of the imaging lens system 11 is shown by the abbreviation IMG. The first lens L1 to the sixth lens L6 are glass lenses.

Note that an optical filter (infrared cut filter, visible/infrared light band-pass filter, or the like) is arranged between the imaging lens system 11 and the capturing element 12, as necessary. Descriptions will be made herein with an example in which an infrared cut filter (IRCF) is arranged between the imaging lens system 11 and the capturing element 12.

The first lens L1 is a glass lens having positive power. An object-side surface S1 of the first lens L1 has a spherical shape with a convex surface facing the object side. An image-side surface S2 of the first lens L1 has a spherical shape with a concave surface facing the image side.

The second lens L2 is a glass lens having negative power. An object-side surface S3 of the second lens L2 has a spherical shape with a convex surface facing the object side. An image-side surface S4 of the second lens L2 has a spherical shape with a concave surface facing the image side.

The third lens L3 is a glass lens having positive power. An object-side surface S5 of the third lens L3 has an aspherical surface shape with a concave surface facing the object side. An image-side surface S6 of the third lens L3 has an aspherical surface shape with a convex surface facing the image side.

The iris STOP is an iris that determines an f-number (F number, Fno) of a lens system. The iris STOP is arranged between the third lens L3 and the fourth lens L4.

The fourth lens L4 is a glass lens having negative power. An object-side surface S9 of the fourth lens L4 has a spherical shape with a convex surface facing the object side. An image-side surface S10 of the fourth lens L4 has a spherical shape with a concave surface facing the image side.

The fifth lens L5 is a glass lens having positive power. An object-side surface S11 of the fifth lens L5 has a spherical shape with a convex surface facing the object side. An image-side surface S12 of the fifth lens L5 has a spherical shape with a convex surface facing the image side.

The sixth lens L6 is a glass lens having positive power. An object-side surface S13 of the sixth lens L6 has an aspherical surface shape with a convex surface facing the object side. An image-side surface S14 of the sixth lens L6 has an aspherical surface shape with a concave surface facing the image side.

The fourth lens L4 and the fifth lens L5 constitute a cemented lens. That is, the image-side surface S10 of the fourth lens L4 and the object-side surface S11 of the fifth lens L5 are in contact with each other. The fourth lens L4 and the fifth lens L5 are bonded by an adhesive layer having a thickness of 0.020 mm on the axis.

The infrared cut filter (IRCF) is a filter for cutting light in the infrared region. When the imaging lens system 11 is designed, the imaging lens system 11 and the infrared cut filter are handled as one integrated component. However, the infrared cut filter is not an essential component of the imaging lens system 11. The infrared cut filter is disposed on the image side of the sixth lens L6.

A sensor cover glass for preventing adhesion of dust to the capturing element 12 may be arranged between the infrared cut filter and the capturing element 12.

Table 1 shows lens data of each lens surface in the imaging lens system 11 according to Example 1. Table 1 shows, as the lens data, a curvature radius (mm), a thickness (mm) between surfaces on the central optical axis, a refractive index nd for a d-line, and an Abbe's number vd for the d-line, of each surface. In Table 1, surfaces marked with “*” are aspherical surfaces.

TABLE 1

| | Curvature | | | |
|---|---|---|---|---|
| | Radius | Thickness | | |
| Surface Number | (mm) | (mm) | Nd | νd |
| Lens Surface S1 | 12.014 | 3.749 | 1.835 | 42.7 |
| Lens Surface S2 | 16.202 | 0.200 | | |
| Lens Surface S3 | 9.056 | 1.398 | 1.835 | 42.7 |
| Lens Surface S4 | 5.434 | 4.573 | | |
| Lens Surface S5 * | −6.104 | 2.858 | 1.768 | 49.2 |
| Lens Surface S6 * | −6.477 | 1.941 | | |
| Iris Surface S7 | INF | 0.028 | | |
| Iris Surface S8 | INF | 1.232 | | |
| Lens Surface S9 | 45.059 | 1.070 | 1.946 | 18.0 |
| Lens Surface S10 | 17.427 | 0.020 | 1.502 | 51.0 |
| Lens Surface S11 | 17.427 | 5.757 | 1.618 | 63.4 |
| Lens Surface S12 | −11.085 | 2.575 | | |
| Lens Surface S13 * | 13.655 | 6.114 | 1.583 | 59.5 |
| Lens Surface S14 * | 12.277 | 2.200 | | |
| IRCF Surface S15 | INF | 0.300 | 1.517 | 64.2 |
| IMG Surface S16 | INF | 3.986 | | |

The aspherical surface shape adopted for the lens surface is expressed by the below-shown expression, in which z is a sag; c is the inverse of the curvature radius; k is a conic constant; r is a height of a ray from an optical axis OA; and α4, α6, α8, α10, α12, α14, and α16 are 4th, 6th, 8th, 10th, 12th, 14th, and 16th order aspherical surface coefficients, respectively.

$$z = \frac{c {r}^{2}}{1 + \sqrt{1 - ( 1 + k ) {c}^{2} {r}^{2}}} + {α}_{4} {r}^{4} + {α}_{6} {r}^{6} + {α}_{8} {r}^{8} + {α}_{10} {r}^{10} + {α}_{12} {r}^{12} + {α}_{14} {r}^{14} + {α}_{16} {r}^{16} \qquad [ Expression 1 ]$$

Table 2 shows aspherical surface coefficients for defining aspherical surface shapes of aspherical lens surfaces in the imaging lens system 11 according to Example 1. Note that, in Table 2, for example, “−1.918528E-06” means “−1.918528×10⁻⁶”. The above-described numerical explanations apply to other tables shown later.

TABLE 2

| | Lens | Lens | Lens | Lens |
|---|---|---|---|---|
| | Surface S5 | Surface S6 | Surface S13 | Surface S14 |
| k | 0.000000E+00 | 0.000000E+00 | 0.000000E+00 | 0.000000E+00 |
| α4 | 4.195965E−05 | 3.285256E−04 | 3.166324E−04 | 9.297233E−04 |
| α6 | −1.918528E−06 | −7.067969E−06 | −8.861213E−07 | 1.146907E−05 |
| α8 | 9.739493E−07 | 1.306363E−06 | 2.678955E−08 | 3.213436E−07 |
| α10 | −3.971284E−08 | −6.153991E−08 | −2.489328E−09 | −4.303932E−08 |
| α12 | 1.214126E−09 | 1.627021E−09 | 8.555796E−11 | 2.820689E−09 |
| α14 | −5.108878E−12 | −1.373521E−11 | −9.297346E−13 | −5.658524E−11 |
| α16 | 0.000000E+00 | 0.000000E+00 | 0.000000E+00 | 0.000000E+00 |

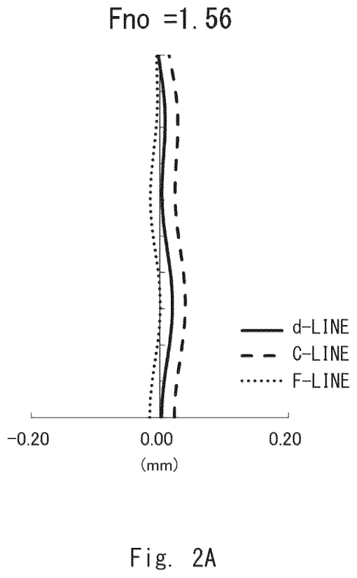

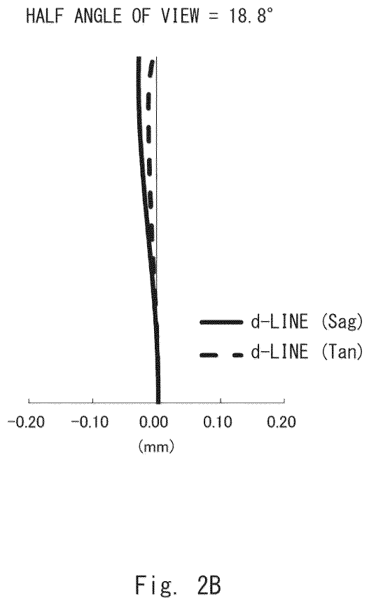

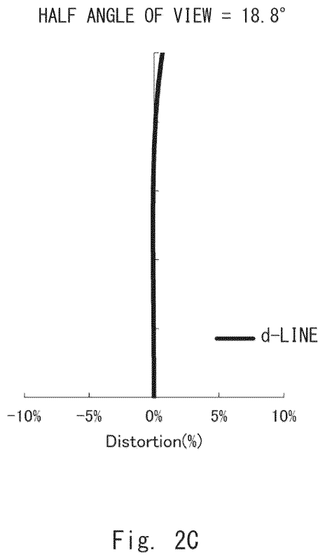

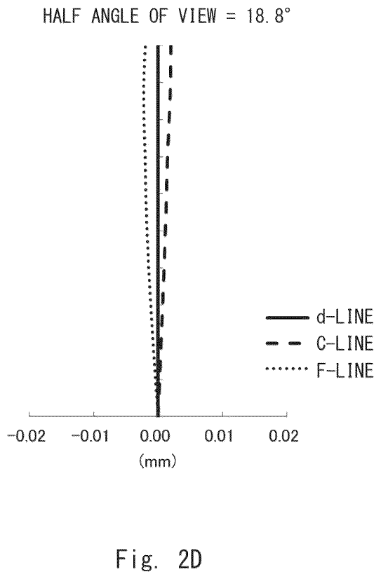

Next, an aberration will be described with reference to the drawings. FIG. 2A to FIG. 2D show a spherical aberration diagram (longitudinal aberration diagram), a field curvature diagram, a distortion diagram, and a lateral color aberration in the imaging lens system 11 according to Example 1. As shown in FIG. 2A to FIG. 2D, in the imaging lens system 11 of Example 1, the F Number is 1.56 and the half angle of view is 18.8°.

In the longitudinal aberration diagram of FIG. 2A, the horizontal axis indicates positions at which the ray intersects the optical axis OA, and the vertical axis indicates passing heights of rays on the incident pupil. Furthermore, FIG. 2A shows results of simulations by a d-line, a C-line, and an F-line.

In the field curvature diagram of FIG. 2B, the horizontal axis indicates distances in the direction of the optical axis OA, and the vertical axis indicates image heights (angle of view). In the field curvature diagram of FIG. 2B, Sag indicates the imaging position in the sagittal ray bundle, and Tan indicates the imaging position in the tangential ray bundle. FIG. 2B shows a result of simulation by the d-line.

In the distortion diagram of FIG. 2C, the horizontal axis indicates distortion (%) of an image, and the vertical axis indicates image heights (angle of view). FIG. 2C shows a result of simulation by a ray of the d-line.

In the lateral color aberration diagram of FIG. 2D, the horizontal axis indicates amounts of the lateral color aberration, and the vertical axis indicates image heights (angle of view).

### Example 2

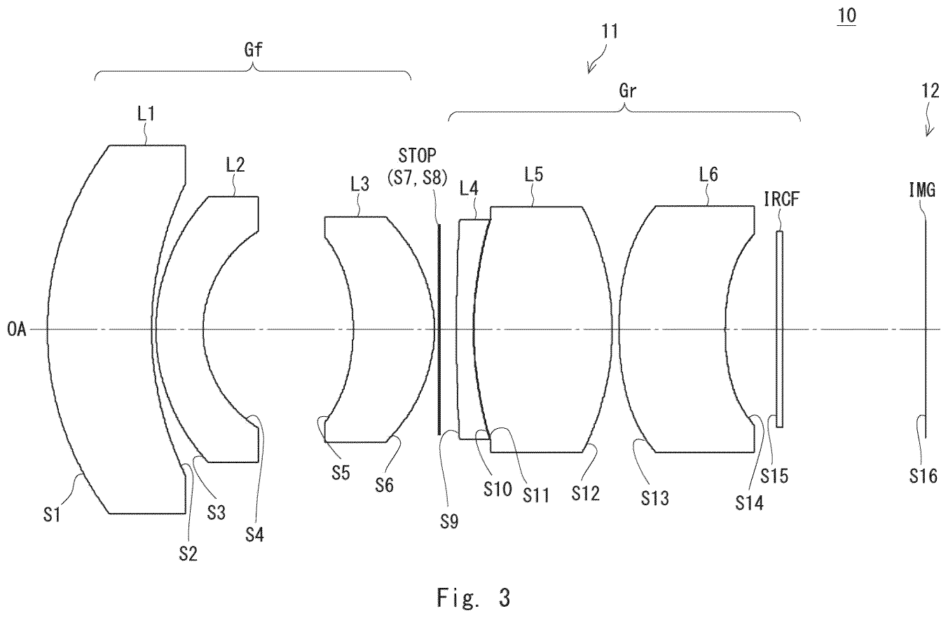

FIG. 3 is a cross-sectional view showing the camera module 10 according to Example 2. Since the imaging lens system 11 according to Example 2 has the same lens configuration as that of Example 1, descriptions thereof will be omitted. Hereinafter, property data of the imaging lens system 11 according to Example 2 will be described.

Table 3 shows lens data of each lens surface in the imaging lens system 11 according to Example 2. Since the items shown in Table 3 are the same as those in Table 1, descriptions thereof are omitted.

TABLE 3

| | Curvature | | | |
|---|---|---|---|---|
| | Radius | Thickness | | |
| Surface Number | (mm) | (mm) | Nd | νd |
| Lens Surface S1 | 13.245 | 4.495 | 1.773 | 49.6 |
| Lens Surface S2 | 14.653 | 0.200 | | |
| Lens Surface S3 | 8.515 | 2.015 | 1.773 | 49.6 |
| Lens Surface S4 | 5.038 | 6.467 | | |
| Lens Surface S5 * | −8.442 | 3.477 | 1.768 | 49.2 |
| Lens Surface S6 * | −6.283 | 0.199 | | |
| Iris Surface S7 | INF | 0.028 | | |
| Iris Surface S8 | INF | 0.745 | | |
| Lens Surface S9 | 80.395 | 0.736 | 1.946 | 18.0 |
| Lens Surface S10 | 16.576 | 0.020 | 1.502 | 51.0 |
| Lens Surface S11 | 16.576 | 5.943 | 1.618 | 63.4 |
| Lens Surface S12 | −11.622 | 0.317 | | |
| Lens Surface S13 * | 16.023 | 4.547 | 1.583 | 59.5 |
| Lens Surface S14 * | 11.651 | 2.200 | | |
| IRCF Surface S15 | INF | 0.300 | 1.517 | 64.2 |
| IMG Surface S16 | INF | 6.140 | | |

Table 4 shows aspherical surface coefficients for defining aspherical surface shapes of aspherical lens surfaces in the imaging lens system 11 according to Example 2. In Table 4, the aspherical surface shape adopted for the lens surface is expressed by an expression similar to that in Example 1.

TABLE 4

| | Lens | Lens | Lens | Lens |
|---|---|---|---|---|
| | Surface S5 | Surface S6 | Surface S13 | Surface S14 |
| k | 0.000000E+00 | 0.000000E+00 | 0.000000E+00 | 0.000000E+00 |
| α4 | −5.804963E−04 | 4.268791E−04 | 9.580685E−04 | 1.481070E−03 |
| α6 | 1.901627E−06 | −4.079361E−06 | −1.891767E−05 | −6.140248E−06 |
| α8 | 7.996399E−08 | 3.355420E−07 | 1.037651E−06 | −4.512683E−08 |
| α10 | −1.365984E−07 | −1.779818E−08 | −4.109653E−08 | 1.795505E−07 |
| α12 | 9.200479E−09 | 6.615609E−10 | 1.069663E−09 | −9.838884E−09 |
| α14 | −2.293305E−10 | −8.311545E−12 | −1.194971E−11 | 1.890669E−10 |
| α16 | 0.000000E+00 | 0.000000E+00 | 0.000000E+00 | 0.000000E+00 |

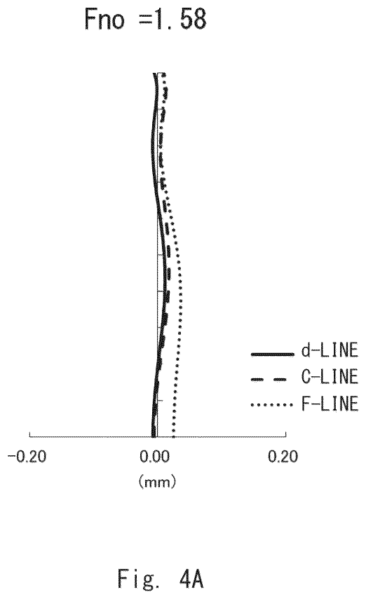

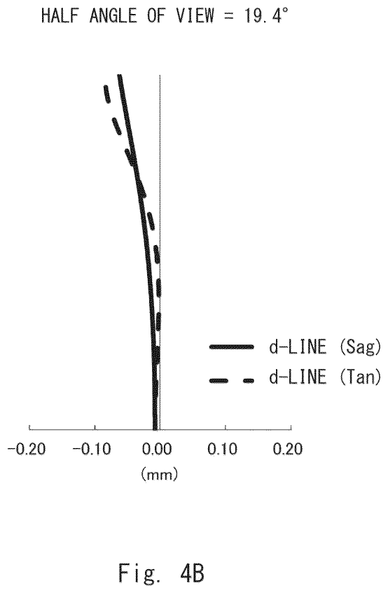

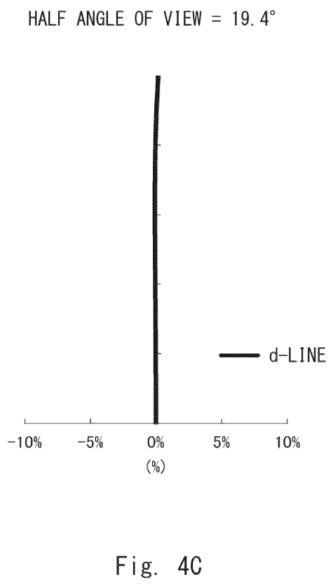

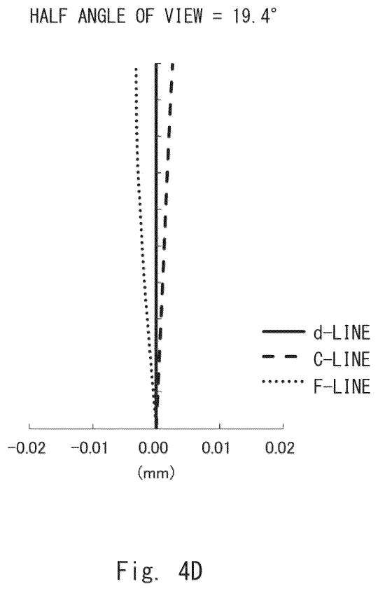

FIG. 4A to FIG. 4D show a spherical aberration diagram (longitudinal aberration diagram), a field curvature diagram, a distortion diagram, and a lateral color aberration diagram in the imaging lens system 11 of Example 2. As shown in FIG. 4A to FIG. 4D, in the imaging lens system 11 of Example 2, the F Number is 1.58, and the half angle of view is 19.4°. Since the description of each aberration diagram shown in FIG. 4A to FIG. 4D is the same as that of FIG. 2A to FIG. 2D, descriptions thereof will be omitted.

### Example 3

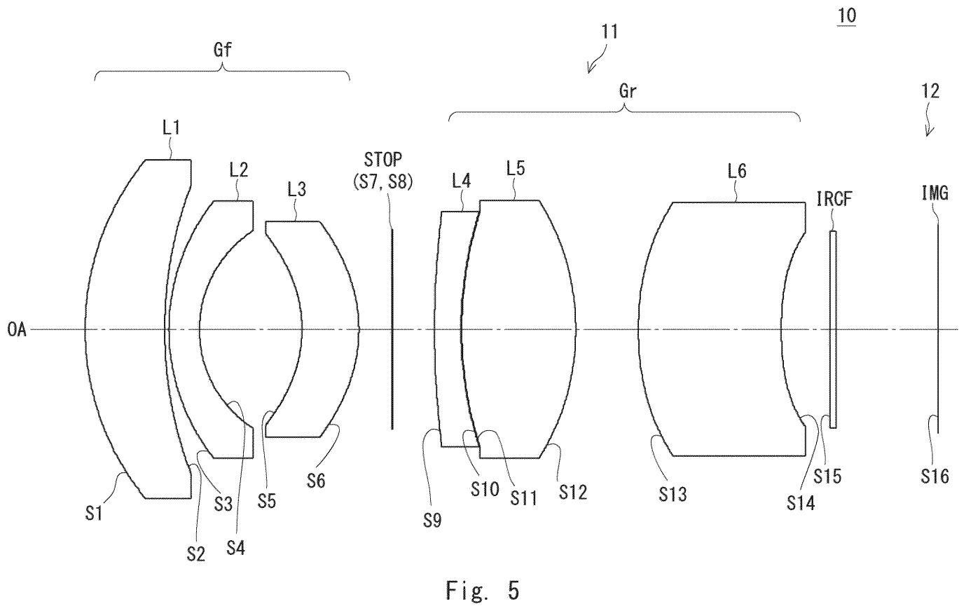

FIG. 5 is a cross-sectional view showing the camera module 10 according to Example 3. Since the imaging lens system 11 according to Example 3 has the same lens configuration as that of Example 1, the description thereof will be omitted. Hereinafter, property data of the imaging lens system 11 according to Example 3 will be described.

Table 5 shows lens data of each lens surface in the imaging lens system 11 according to Example 3. Since the items shown in Table 5 are the same as those in Table 1, descriptions thereof are omitted.

TABLE 5

| | Curvature | | | |
|---|---|---|---|---|
| | Radius | Thickness | | |
| Surface Number | (mm) | (mm) | Nd | νd |
| Lens Surface S1 | 11.958 | 3.582 | 1.871 | 40.7 |
| Lens Surface S2 | 18.083 | 0.200 | | |
| Lens Surface S3 | 9.354 | 1.340 | 1.871 | 40.7 |
| Lens Surface S4 | 5.312 | 4.611 | | |
| Lens Surface S5 * | −5.927 | 2.569 | 1.768 | 49.2 |
| Lens Surface S6 * | −6.667 | 1.457 | | |
| Iris Surface S7 | INF | 0.028 | | |
| Iris Surface S8 | INF | 1.878 | | |
| Lens Surface S9 | 42.918 | 1.207 | 1.946 | 18.0 |
| Lens Surface S10 | 18.003 | 0.020 | 1.502 | 51.0 |
| Lens Surface S11 | 18.003 | 5.119 | 1.618 | 63.4 |
| Lens Surface S12 | −10.949 | 2.799 | | |
| Lens Surface S13 * | 13.355 | 6.371 | 1.583 | 59.5 |
| Lens Surface S14 * | 13.603 | 2.200 | | |
| IRCF Surface S15 | INF | 0.300 | 1.517 | 64.2 |
| IMG Surface S16 | INF | 4.519 | | |

Table 6 shows aspherical surface coefficients for defining aspherical surface shapes of aspherical lens surfaces in the imaging lens system 11 of Example 3. In Table 6, the aspherical surface shape adopted for the lens surface is expressed by an expression similar to that in Example 1.

TABLE 6

| | Lens | Lens | Lens | Lens |
|---|---|---|---|---|
| | Surface S5 | Surface S6 | Surface S13 | Surface S14 |
| k | 0.000000E+00 | 0.000000E+00 | 0.000000E+00 | 0.000000E+00 |
| α4 | 3.387178E−04 | 3.922060E−04 | 2.721940E−04 | 8.222873E−04 |
| α6 | 3.199952E−06 | 2.905918E−07 | −6.363852E−08 | 1.399805E−05 |
| α8 | 1.093780E−06 | 5.861580E−07 | −1.316875E−08 | −2.706012E−08 |
| α10 | −3.659182E−08 | −1.816260E−08 | −9.297877E−10 | −3.634918E−08 |
| α12 | 7.854662E−10 | 3.743283E−10 | 4.599208E−11 | 2.716252E−09 |
| α14 | 4.245053E−12 | −6.136968E−13 | −5.673147E−13 | −5.526897E−11 |
| α16 | 0.000000E+00 | 0.000000E+00 | 0.000000E+00 | 0.000000E+00 |

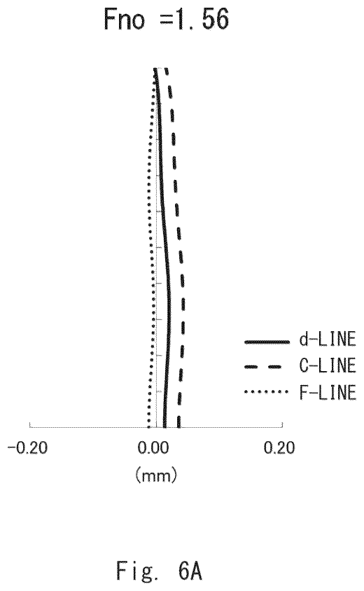

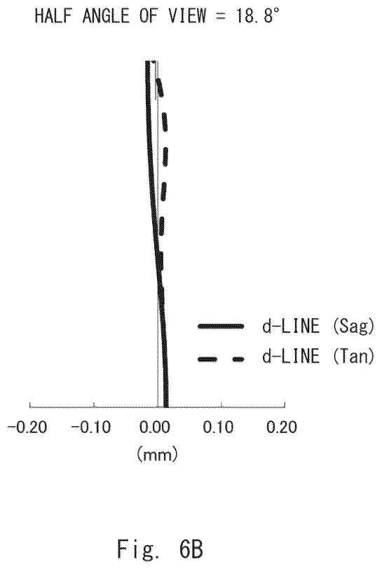

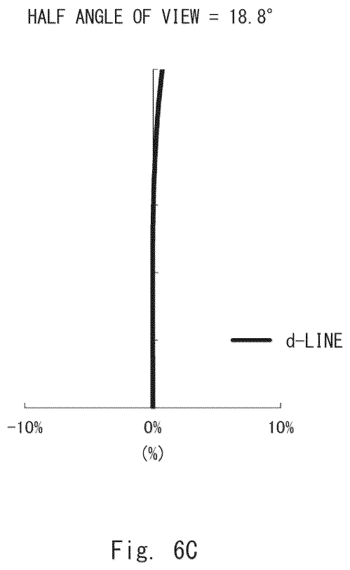

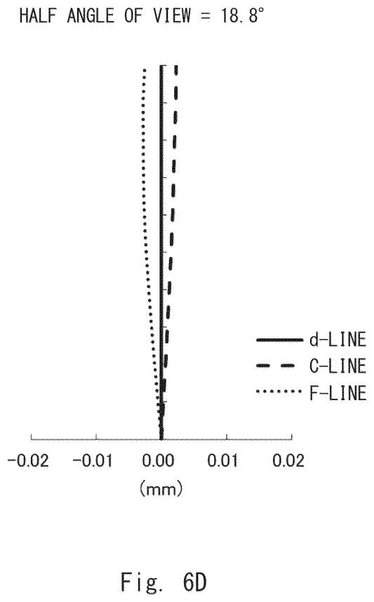

FIG. 6A to FIG. 6D show a spherical aberration diagram (longitudinal aberration diagram), a field curvature diagram, a distortion diagram, and a lateral color aberration diagram in the imaging lens system 11 of Example 3. As shown in FIG. 6A to FIG. 6D, in the imaging lens system 11 of Example 3, the F Number is 1.56, and the half angle of view is 18.8°. Since the description of each aberration diagram shown in FIG. 6A to FIG. 6D is the same as that of FIG. 2A to FIG. 2D, the description thereof will be omitted.

### Example 4

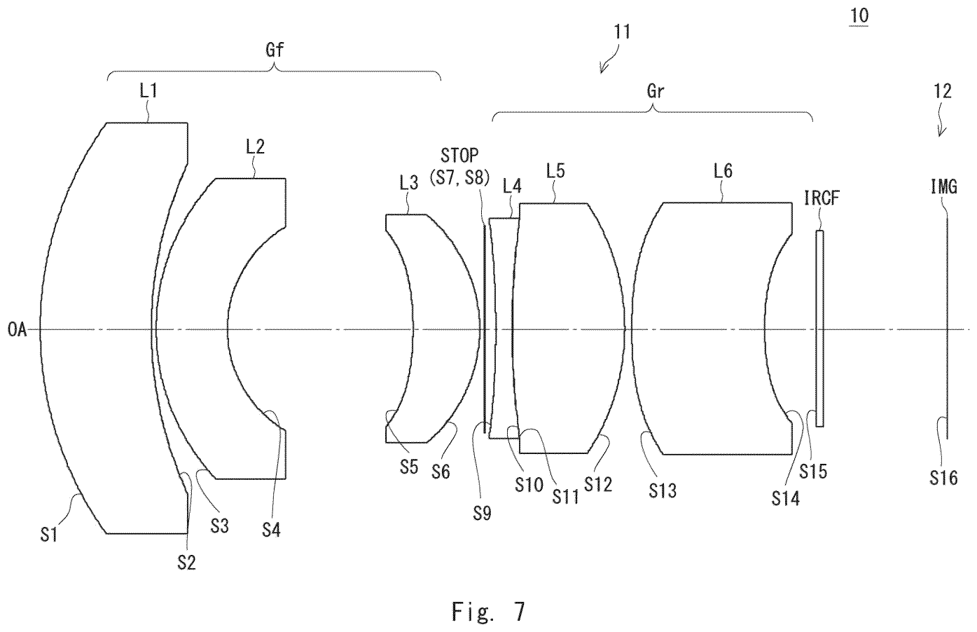

FIG. 7 is a cross-sectional view showing the camera module 10 according to Example 4. The imaging lens system 11 according to Example 4 differs from

Example 1 in that the object-side surface S9 of the fourth lens L4 has a spherical shape whose concave surface faces the object side. Hereinafter, property data of the imaging lens system 11 according to Example 4 will be described.

Table 7 shows lens data of each lens surface in the imaging lens system 11 according to Example 4. Since the items shown in Table 7 are the same as those in Table 1, descriptions thereof are omitted.

TABLE 7

| | Curvature | | | |
|---|---|---|---|---|
| | Radius | Thickness | | |
| Surface Number | (mm) | (mm) | Nd | νd |
| Lens Surface S1 | 15.069 | 4.700 | 1.773 | 49.6 |
| Lens Surface S2 | 16.949 | 0.200 | | |
| Lens Surface S3 | 9.327 | 3.001 | 1.773 | 49.6 |
| Lens Surface S4 | 5.056 | 7.846 | | |
| Lens Surface S5 * | −12.033 | 2.812 | 1.768 | 49.2 |
| Lens Surface S6 * | −6.070 | 0.192 | | |
| Iris Surface S7 | INF | 0.028 | | |
| Iris Surface S8 | INF | 0.457 | | |
| Lens Surface S9 | −38.210 | 0.700 | 1.946 | 18.0 |
| Lens Surface S10 | 36.674 | 0.020 | 1.502 | 51.0 |
| Lens Surface S11 | 36.674 | 4.713 | 1.618 | 63.4 |
| Lens Surface S12 | −9.743 | 0.299 | | |
| Lens Surface S13 * | 18.034 | 5.600 | 1.583 | 59.5 |
| Lens Surface S14 * | 10.792 | 2.200 | | |
| IRCF Surface S15 | INF | 0.300 | 1.517 | 64.2 |
| IMG Surface S16 | INF | 5.237 | | |

Table 8 shows aspherical surface coefficients for defining aspherical surface shapes of aspherical lens surfaces in the imaging lens system 11 of Example 4. In Table 8, the aspherical surface shape adopted for the lens surface is expressed by an expression similar to that in Example 1.

TABLE 8

| | Lens | Lens | Lens | Lens |
|---|---|---|---|---|
| | Surface S5 | Surface S6 | Surface S13 | Surface S14 |
| k | 0.000000E+00 | 0.000000E+00 | 0.000000E+00 | 0.000000E+00 |
| α4 | −8.903773E−04 | 4.526189E−04 | 7.771110E−04 | 1.300715E−03 |
| α6 | −3.669257E−05 | −2.098301E−05 | −7.224762E−06 | −9.772075E−06 |
| α8 | 5.417924E−06 | 2.121324E−06 | −1.542739E−07 | 9.853535E−07 |
| α10 | −6.179620E−07 | −1.502520E−07 | 2.402196E−08 | 3.462682E−08 |
| α12 | 3.019014E−08 | 5.410726E−09 | −7.484664E−10 | −1.877293E−10 |
| α14 | −5.897294E−10 | −7.525723E−11 | 7.861854E−12 | −4.571754E−11 |
| α16 | 0.000000E+00 | 0.000000E+00 | 0.000000E+00 | 0.000000E+00 |

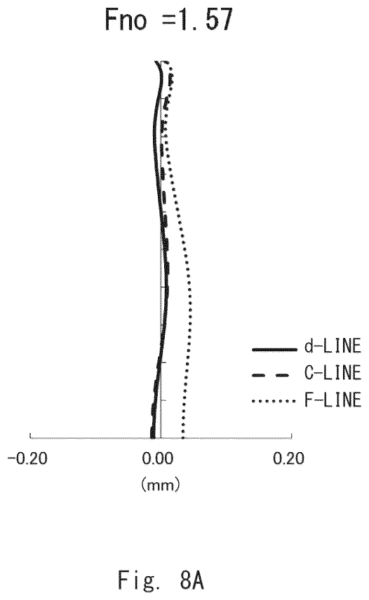

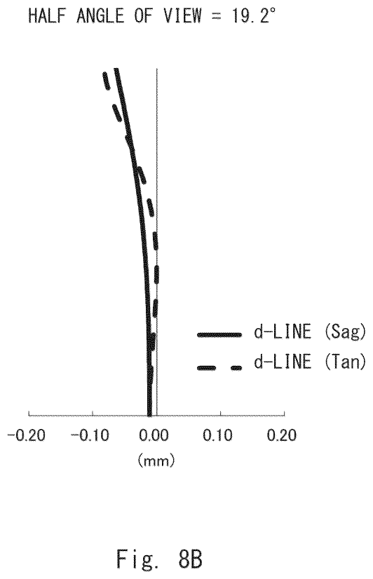

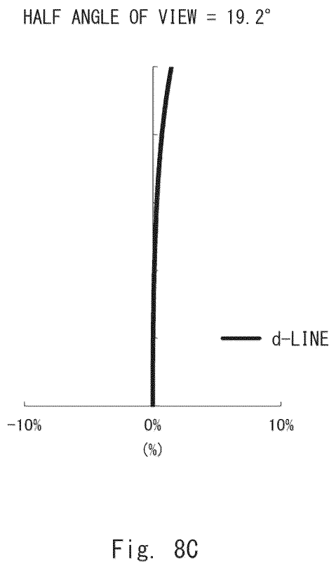

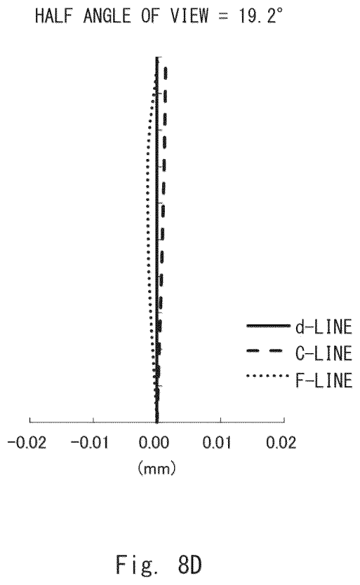

FIG. 8A to FIG. 8D show a spherical aberration diagram (longitudinal aberration diagram), a field curvature diagram, a distortion diagram, and a lateral color aberration diagram in the imaging lens system 11 of Example 4. As shown in FIG. 8A to FIG. 8D, in the imaging lens system 11 of Example 4, the F Number is 1.57, and the half angle of view is 19.2°. Since the description of each aberration diagram shown in FIG. 8A to FIG. 8D is the same as that of FIG. 2A to FIG. 2D, descriptions thereof are omitted.

### Example 5

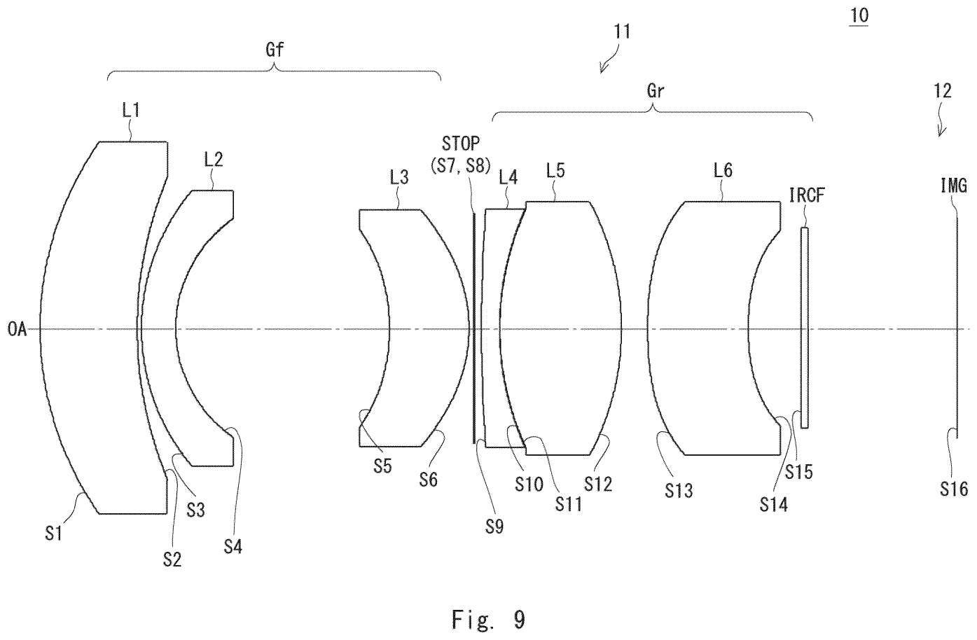

FIG. 9 is a cross-sectional view showing the camera module 10 according to Example 5. Since it has the same lens configuration as that of Example 1, descriptions thereof will be omitted. Hereinafter, property data of the imaging lens system 11 according to Example 5 will be described.

Table 9 shows lens data of each lens surface in the imaging lens system 11 according to Example 5. Since the items shown in Table 9 are the same as those in Table 1, descriptions thereof are omitted.

TABLE 9

| | Curvature | | | |
|---|---|---|---|---|
| | Radius | Thickness | | |
| Surface Number | (mm) | (mm) | Nd | νd |
| Lens Surface S1 | 13.628 | 4.038 | 1.835 | 42.7 |
| Lens Surface S2 | 16.405 | 0.200 | | |
| Lens Surface S3 | 8.950 | 1.434 | 1.835 | 42.7 |
| Lens Surface S4 | 5.604 | 8.931 | | |
| Lens Surface S5 * | −8.194 | 3.314 | 1.768 | 49.2 |
| Lens Surface S6 * | −6.305 | 0.199 | | |
| Iris Surface S7 | INF | 0.028 | | |
| Iris Surface S8 | INF | 0.299 | | |
| Lens Surface S9 | 74.597 | 0.748 | 1.847 | 23.8 |
| Lens Surface S10 | 12.249 | 0.020 | 1.502 | 51.0 |
| Lens Surface S11 | 12.249 | 5.078 | 1.618 | 63.4 |
| Lens Surface S12 | −11.235 | 1.073 | | |
| Lens Surface S13 * | 17.349 | 4.212 | 1.583 | 59.5 |
| Lens Surface S14 * | 9.915 | 2.200 | | |
| IRCF Surface S15 | INF | 0.300 | 1.517 | 64.2 |
| IMG Surface S16 | INF | 6.264 | | |

Table 10 shows aspherical surface coefficients for defining aspherical surface shapes of aspherical lens surfaces in the imaging lens system 11 of Example 5. In Table 10, the aspherical surface shape adopted for the lens surface is expressed by an expression similar to that in Example 1.

TABLE 10

| | Lens | Lens | Lens | Lens |
|---|---|---|---|---|
| | Surface S5 | Surface S6 | Surface S13 | Surface S14 |
| K | 0.000000E+00 | 0.000000E+00 | 0.000000E+00 | 0.000000E+00 |
| α4 | −3.703091E−04 | 5.460983E−04 | 1.115354E−03 | 1.501932E−03 |
| α6 | −2.443857E−05 | −7.556684E−06 | −2.154925E−05 | −2.728424E−05 |
| α8 | 5.424663E−06 | 1.212457E−06 | 7.693467E−07 | 3.590497E−06 |
| α10 | −4.813680E−07 | −6.171290E−08 | −9.553359E−09 | −2.391134E−07 |
| α12 | 1.992196E−08 | 1.725656E−09 | −9.905904E−11 | 1.386440E−08 |
| α14 | −3.174741E−10 | −1.536950E−11 | 3.492595E−12 | −2.924376E−10 |
| α16 | 0.000000E+00 | 0.000000E+00 | 0.000000E+00 | 0.000000E+00 |

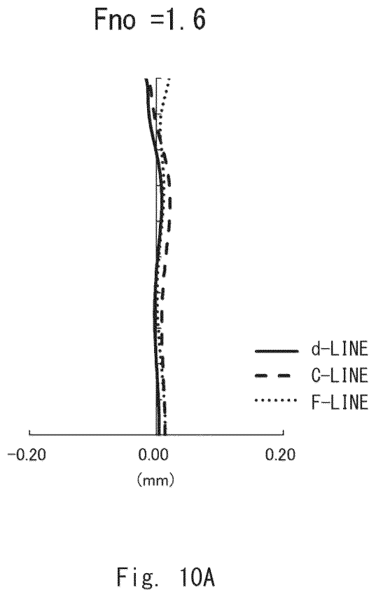

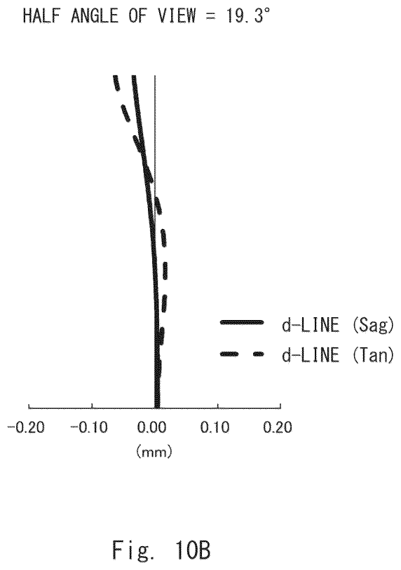

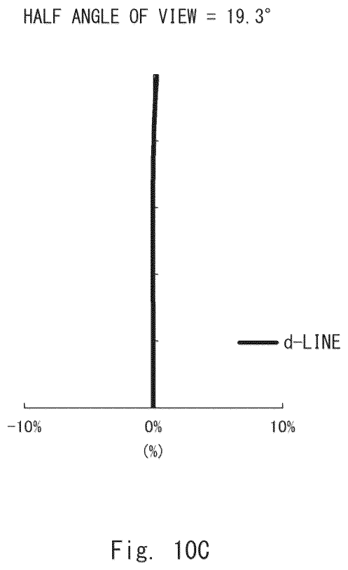

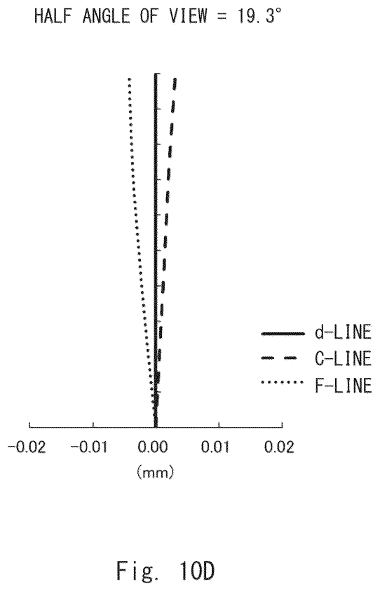

FIG. 10A to FIG. 10D show a spherical aberration diagram (longitudinal aberration diagram), a field curvature diagram, a distortion diagram, and a lateral color aberration diagram in the imaging lens system 11 of Example 5. As shown in FIG. 10A to FIG. 10D, in the imaging lens system 11 of Example 5, the F Number is 1.60, and the half angle of view is 19.3°. Since the description of each aberration diagram shown in FIG. 10A to FIG. 10D is the same as that of FIG. 2A to FIG. 2D, descriptions thereof are omitted.

### Example 6

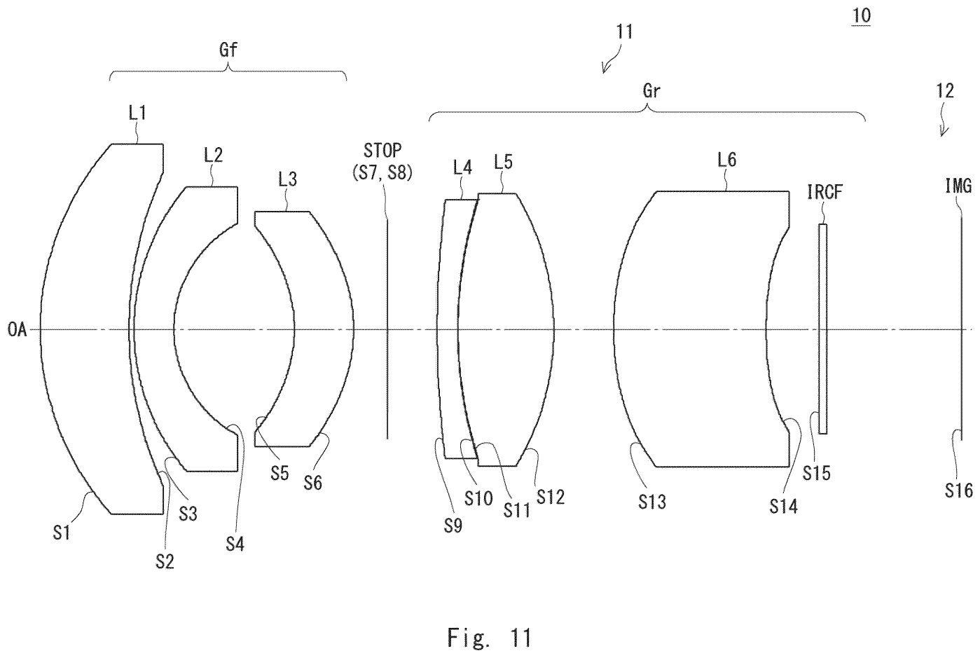

FIG. 11 is a cross-sectional view showing the camera module 10 according to Example 6. Since the imaging lens system 11 according to Example 6 has the same lens configuration as that of Example 1, descriptions thereof are omitted. Hereinafter, property data of the imaging lens system 11 according to Example 6 will be described.

Table 11 shows lens data of each lens surface in the imaging lens system 11 according to Example 6. Since the items shown in Table 11 are the same as those in Table 1, descriptions thereof are omitted.

TABLE 11

| | Curvature | | | |
|---|---|---|---|---|
| | Radius | Thickness | | |
| Surface Number | (mm) | (mm) | Nd | νd |
| Lens Surface S1 | 11.689 | 3.695 | 1.835 | 42.7 |
| Lens Surface S2 | 15.642 | 0.200 | | |
| Lens Surface S3 | 9.180 | 1.695 | 1.835 | 42.7 |
| Lens Surface S4 | 5.059 | 5.009 | | |
| Lens Surface S5 * | −5.983 | 2.459 | 1.768 | 49.2 |
| Lens Surface S6 * | −6.639 | 1.408 | | |
| Iris Surface S7 | INF | 0.028 | | |
| Iris Surface S8 | INF | 2.046 | | |
| Lens Surface S9 | 44.559 | 0.850 | 1.946 | 18.0 |
| Lens Surface S10 | 18.221 | 0.020 | 1.502 | 51.0 |
| Lens Surface S11 | 18.221 | 3.996 | 1.593 | 67.0 |
| Lens Surface S12 | −11.067 | 2.491 | | |
| Lens Surface S13 * | 12.787 | 6.380 | 1.583 | 59.5 |
| Lens Surface S14 * | 17.108 | 2.200 | | |
| IRCF Surface S15 | INF | 0.300 | 1.517 | 64.2 |
| IMG Surface S16 | INF | 5.624 | | |

Table 12 shows aspherical surface coefficients for defining aspherical surface shapes of aspherical lens surfaces in the imaging lens system 11 of Example 6. In Table 12, the aspherical surface shape adopted for the lens 5 surface is expressed by an expression similar to that of Example 1.

TABLE 12

| | Lens | Lens | Lens | Lens |
|---|---|---|---|---|
| | Surface S5 | Surface S6 | Surface S13 | Surface S14 |
| k | 0.000000E+00 | 0.000000E+00 | 0.000000E+00 | 0.000000E+00 |
| α4 | 4.336840E−04 | 4.450147E−04 | 3.623295E−04 | 8.987555E−04 |
| α6 | 6.721337E−06 | 3.677787E−06 | −1.448556E−07 | 6.278809E−06 |
| α8 | 4.917000E−07 | 1.467594E−07 | −1.627804E−08 | 2.335979E−07 |
| α10 | −2.334056E−09 | −9.375022E−10 | 2.274012E−09 | 3.806615E−08 |
| α12 | −1.264240E−09 | −1.563579E−10 | −7.253075E−11 | −3.153322E−09 |
| α14 | 3.203554E−11 | 4.035195E−12 | 9.993010E−13 | 8.884103E−11 |
| α16 | 0.000000E+00 | 0.000000E+00 | 0.000000E+00 | 0.000000E+00 |

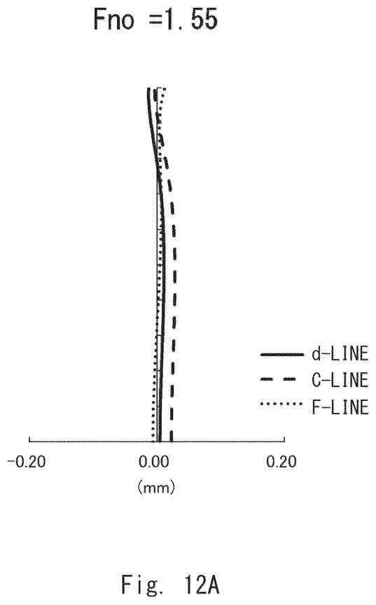

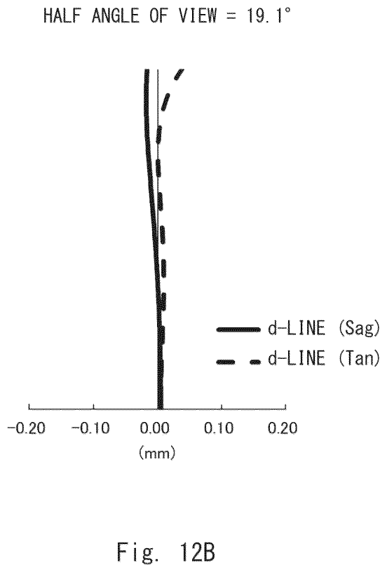

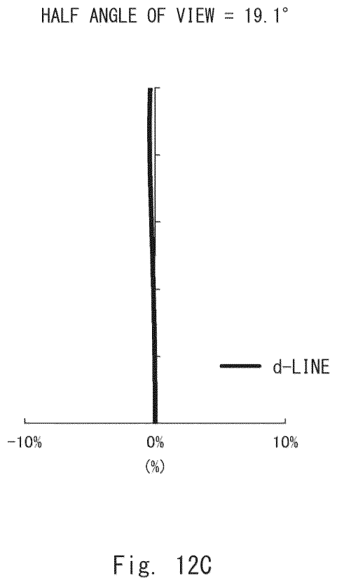

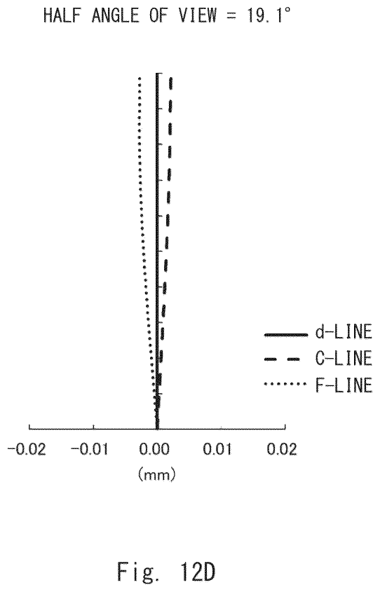

FIG. 12A to FIG. 12D show a spherical aberration diagram (longitudinal aberration diagram), a field curvature diagram, a distortion diagram, and a lateral color aberration diagram in the imaging lens system 11 of Example 6. As shown in FIG. 12A to FIG. 12D, in the imaging lens system 11 of Example 6, the F Number is 1.55, and the half angle of view is 19.1°. Since the description of each aberration diagram shown in FIG. 12A to FIG. 12D is the same as that of FIG. 2A to FIG. 2D, descriptions thereof are omitted.

Table 13 shows an F Number of the imaging lens system 11, a whole angle of view of the imaging lens system 11, a total track length of the imaging lens system 11, a focal length f of the entire optical system of the imaging lens system 11, a d-line refractive index nd1 of the first lens L1, a d-line refractive index nd2 of the second lens L2, a value of f3/f, an Abbe's number vd4 of the fourth lens L4, a value of f6/f, a value of dNd5/dt, a value of f45/f, a focal length f1 of the first lens L1, a focal length f2 of the second lens L2, a focal length f3 of the third lens L3, a focal length f4 of the fourth lens L4, a focal length f5 of the fifth lens L5, a focal length f6 of the sixth lens L6, and a composite focal length f45 of the fourth lens L4 and the fifth lens L5. In Table 13, the units of the focal length and the total track length are both mm. The unit of the angle of view is. The focal length and the total length shown in Table 13 are calculated using a wavelength ray of 550 nm.

TABLE 13

| | Example | Example | Example | Example | Example | Example |
|---|---|---|---|---|---|---|
| | 1 | 2 | 3 | 4 | 5 | 6 |
| F Number | 1.56 | 1.58 | 1.56 | 1.57 | 1.60 | 1.55 |
| Whole angle of | 37.6 | 38.8 | 37.5 | 38.4 | 38.6 | 38.2 |
| view | | | | | | |
| Total track | 38.00 | 37.83 | 38.20 | 38.30 | 38.34 | 38.40 |
| length | | | | | | |
| f | 13.47 | 13.10 | 13.51 | 13.10 | 13.15 | 13.40 |
| nd1 | 1.835 | 1.773 | 1.871 | 1.773 | 1.835 | 1.835 |
| nd2 | 1.835 | 1.773 | 1.871 | 1.773 | 1.835 | 1.835 |
| f3/f | 4.37 | 1.43 | 10.01 | 1.01 | 1.53 | 9.28 |
| νd4 | 17.98 | 17.98 | 17.98 | 17.98 | 23.78 | 17.98 |
| f6/f | 24.19 | −9.04 | 8.84 | −4.91 | −3.80 | 4.18 |
| dNd5/dt | −2.2 | −2.2 | −2.2 | −2.2 | −2.2 | −0.7 |
| (×10⁻⁶/° C.) | | | | | | |
| f45/f | 1.30 | 1.64 | 1.25 | 2.10 | 1.56 | 1.36 |
| f1 | 39.33 | 74.19 | 31.69 | 83.68 | 57.68 | 38.66 |
| f2 | −19.65 | −21.30 | −16.62 | −20.54 | −22.22 | −16.53 |
| f3 | 58.85 | 18.72 | 135.19 | 13.17 | 20.10 | 124.31 |
| f4 | −30.27 | −21.94 | −33.19 | −19.47 | −17.25 | −32.73 |
| f5 | 11.84 | 11.98 | 11.78 | 12.92 | 10.30 | 12.18 |
| f6 | 325.89 | −118.40 | 119.42 | −64.26 | −50.00 | 55.99 |
| f45 | 17.54 | 21.54 | 16.95 | 27.56 | 20.54 | 18.22 |

In Examples 1 to 6, the imaging lens system 11 satisfies the numerical ranges of the above Conditional Expressions (1), (2).

Thus, by applying a glass material having a high refractive index to the first lens and the second lens, power of the first lens and the second lens can be made strong, and distortions and field curvatures can be corrected. In Examples 1 to 6,the imaging lens system satisfies the numerical range of the above Conditional Expression (3). Thus, the power of the third lens with respect to the power of the entire optical system can be set to an optimal range, and distortions and field curvatures can be corrected. Therefore, it becomes possible to take more light into the imaging lens system. Accordingly, the imaging lens system which has a sufficiently high resolution and is sufficiently bright can be achieved. In fact, as shown in FIG. 2A to FIG. 2D, FIG. 4A to FIG. 4D, FIG. 6A to FIG. 6D, FIG. 8A to FIG. 8D, FIG. 10A to FIG. 10D, and FIG. 12A to FIG. 12D, the imaging lens system 11 according to Examples 1 to 6 optimally reduces spherical aberrations, distortions, and field curvatures, and excellent imaging performance and a high resolution are achieved.

In addition, the imaging lens system can be constituted of six lenses, and the cost can be reduced. Thus, the imaging lens system and the camera module having sufficient brightness with reduced cost can be provided.

In Examples 1 to 6, the imaging lens system 11 satisfies the numerical range of the above Conditional Expression (4). Thus, color aberrations on the axis can be corrected. Therefore, it becomes possible to take more light into the imaging lens system. Accordingly, the imaging lens system which has a sufficiently high resolution and is sufficiently bright can be achieved. In fact, as shown in FIG. 2A to FIG. 2D, FIG. 4A to FIG. 4D, FIG. 6A to FIG. 6D, FIG. 8A to FIG. 8D, FIG. 10A to FIG. 10D, and FIG. 12A to FIG. 12D, the imaging lens system 11 according to Examples 1 to 6 optimally reduces color aberrations, and excellent imaging performance and a high resolution are achieved.

In Examples 1 to 6, the object-side surface and the image-side surface of the third lens L3 and the object-side surface and the image-side surface of the sixth lens L6 have aspherical surface shapes. Thus, chief aberrations can be effectively corrected, and the imaging lens system having a high resolution can be implemented. In fact, as shown in FIG. 2A to FIG. 2D, FIG. 4A to FIG. 4D, FIG. 6A to FIG. 6D, FIG. 8A to FIG. 8D, FIG. 10A to FIG. 10D, and FIG. 12A to FIG. 12D, the imaging lens system 11 according to Examples 1 to 6 optimally reduces each aberration, and excellent imaging performance and a high resolution are achieved.

In Examples 1 to 6, the imaging lens system 11 satisfies the numerical range of the above Conditional Expression (5). Thus, field curvatures can be corrected, and the imaging lens system having a high resolution and sufficient brightness can be implemented. In fact, as shown in FIG. 2A to FIG. 2D, FIG. 4A to FIG. 4D, FIG. 6A to FIG. 6D, FIG. 8A to FIG. 8D, FIG. 10A to FIG. 10D, and FIG. 12A to FIG. 12D, the imaging lens system 11 according to Examples 1 to 6 optimally reduces field curvatures, and excellent imaging performance and a high resolution are achieved.

In Examples 1 to 6, the imaging lens system 11 satisfies the numerical range of the above Conditional Expression (6). Thus, a shift of the focal length f in the entire imaging lens system 11 due to a temperature change can be suppressed. Table 14 shows a focus shift range (μm) in accordance with an environmental temperature change of the focal length f in the imaging lens system 11 of Examples 1 to 6. Table 14 shows a focus shift range from the focal length f at room temperature 25° C.

TABLE 14

| | | Focus shift range (μm) | | | | | |
|---|---|---|---|---|---|---|---|
| Temperature | | Example | Example | Example | Example | Example | Example |
| (° C.) | | 1 | 2 | 3 | 4 | 5 | 6 |
| −40° | C. | −11 | −10 | −10 | −7 | −5 | −7 |
| 25° | C. | 0 | 0 | 0 | 0 | 0 | 0 |
| 105° | C. | 13 | 11 | 13 | 10 | 7 | 10 |

As shown in Table 14, the focus shift range of the focal length fin accordance with the environmental temperature change of the imaging lens system 11 according to Examples 1 to 6 is suppressed to about ±10 μm at −40° C. or higher and 105° C. or lower. Accordingly, in Examples 1 to 6, a shift of the focal length f in the entire imaging lens system 11 due to a temperature change can be suppressed.

In Examples 1 to 6, an iris is arranged between the third lens L3 and the fourth lens L4. Thus, various aberrations such as transverse aberrations and field curvatures can be sufficiently corrected. In fact, as shown in FIG. 2A to FIG. 2D, FIG. 4A to FIG. 4D, FIG. 6A to FIG. 6D, FIG. 8A to FIG. 8D, FIG. 10A to FIG. 10D, and FIG. 12A to FIG. 12D, the imaging lens system 11 according to Examples 1 to 6 optimally reduces field curvatures and lateral color aberrations, and excellent imaging performance and a high resolution are achieved.

In Examples 1 to 6, the fourth lens L4 and the fifth lens L5 constitute a cemented lens. Thus, color aberrations such as color aberrations on the axis and lateral color aberrations can be corrected with the cemented lens. In fact, as shown in FIG. 2A to FIG. 2D, FIG. 4A to FIG. 4D, FIG. 6A to FIG. 6D, FIG. 8A to FIG. 8D, FIG. 10A to FIG. 10D, and FIG. 12A to FIG. 12D, the imaging lens system 11 according to Examples 1 to 6 optimally reduces lateral color aberrations, and excellent imaging performance and a high resolution are achieved.

In Examples 1 to 6, the numerical range of the above Conditional Expression (7) is satisfied. Thus, color aberrations such as color aberrations on the axis and lateral color aberrations can be corrected, and the imaging lens system having a sufficiently high resolution and is sufficiently bright can be achieved. In fact, as shown in FIG. 2A to FIG. 2D, FIG. 4A to FIG. 4D, FIG. 6A to FIG. 6D, FIG. 8A to FIG. 8D, FIG. 10A to FIG. 10D, and FIG. 12A to FIG. 12D, the imaging lens system 11 according to Examples 1 to 6 optimally reduces lateral color aberrations, and excellent imaging performance and a high resolution are achieved.

With the camera module 10 including the imaging lens system 11, the cost of the camera module 10 can be reduced, and since the imaging lens system 11 has sufficient brightness required for image recognition in autonomous driving, precision of sensing the camera module 10 can be made higher.

### Third Embodiment

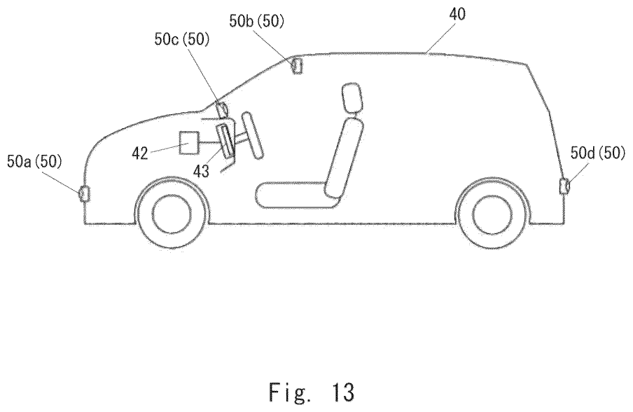

FIG. 13 is an overview diagram of a car 40 on which an in-vehicle system is mounted. The in-vehicle system includes capturing apparatuses 50 each including the imaging lens system 11 according to the first embodiment or second embodiment and a capturing element 12 for converting light converged therethrough into electrical signals. As shown in the drawing, the capturing apparatus 50 can be mounted on the car 40. FIG. 13 is an example arrangement exemplifying positions on the car 40 where the capturing apparatuses 50 are mounted. The capturing apparatuses 50 mounted on the car 40 may also be referred to as on-board cameras and may be installed at various positions on the car 40. For example, a first capturing apparatus 50a may be arranged on or near the front bumper as a camera to monitor the front area of the car 40 as it travels. A second capturing apparatus 50b for monitoring the front area may be arranged near the inner rearview mirror inside the vehicle compartment of the car 40. A third capturing apparatus 50c may be arranged on the dashboard, inside the instrument panel or the like as a camera for monitoring the driver's driving condition. A fourth capturing apparatus 50d may be installed at the rear of the car 40 for monitoring the rear area of the car 40. The capturing apparatuses 50a and 50b may be referred to as front cameras. The third capturing apparatus 50c may be referred to as an in-camera. The fourth capturing apparatus 50d may be referred to as a rear camera. The capturing apparatuses 50 are not limited to these, but also include capturing apparatuses installed at various positions, such as a left-side camera capturing images on the left rear side and a right-side camera capturing images on the right rear side.

Image signals of the images captured by the capturing apparatuses 50 may be output to an information processing apparatus 42 and/or a display apparatus 43 or the like inside the car 40. The information processing apparatus 42 and display apparatus 43 constitute the in-vehicle system together with the capturing apparatuses 50. The information processing apparatus 42 inside the car 40 includes an apparatus that processes the image signals acquired by the capturing apparatuses 50, recognizes the recognition of various objects in the captured images, and assists the driver in driving. The information processing apparatus 42 also includes, but is not limited to, for example, a navigation apparatus, a collision damage reduction brake apparatus, a distance control apparatus, a lane departure warning apparatus, and the like. The display apparatus 43 displays the images processed and output by the information processing apparatus 42, and may also receive the image signals directly from the capturing apparatuses 50. The display apparatus 43 may also employ, but is not limited to, a Liquid Crystal Display (LCD), an organic EL (Electro-Luminescence) display, and an inorganic EL display. The display apparatus 43 may display to the driver the image signals output from the capturing apparatuses 50 that capture images at positions difficult to be seen by the driver, such as a rear camera.

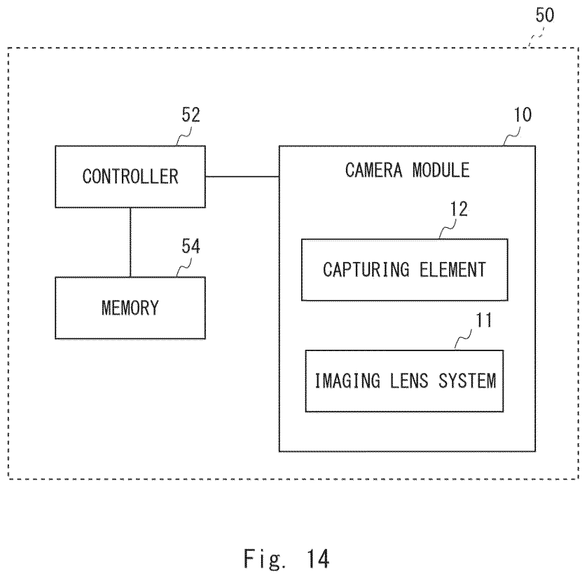

FIG. 14 shows the configuration of the capturing apparatus 50 constituting the in-vehicle system of FIG. 13. As shown in the drawing, the capturing apparatus 50 according to one embodiment includes a controller 52, a memory 54, and the camera module 10.

The controller 52 controls the camera module 10 and processes electrical signals output from the capturing element 12 of the camera module 10. The controller 52 may be configured as, for example, a processor. The controller 52 may also include one or more processors. The processor may include a general purpose processor that loads a specific program to perform a specific function, and a dedicated processor specialized in a specific process. The dedicated processor may include an application specific IC (Integrated Circuit). The application specific IC is also referred to as an ASIC (Application Specific Integrated Circuit). The processor may include a programmable logic device. A programmable logic device is also referred to as a PLD (Programmable Logic Device). A PLD may include a FPGA (Field-Programmable Gate Array). The controller 52 may be either a SoC (System-on-a-Chip) with one or more processors working together, or a SiP (System In a Package).

The memory 54 stores various information or parameters related to the operation of the capturing apparatuses 50. The memory 54 may be composed of, for example, a semiconductor memory and the like. The memory 54 may function as a work memory for the controller 52. The memory 54 may store the captured images. The memory 54 may store various parameters and the like for the controller 52 to perform detection processing based on the captured images. The memory 54 may be included in the controller 52.

As described above, the camera module 10 uses the capturing element 12 to capture a subject image formed through the imaging lens system 11, and outputs the imaged image. The image captured by the camera module 10 is also referred to as the captured image.

The capturing element 12 may be composed of, for example, a CMOS (Complementary Metal Oxide Semiconductor) image sensor, a CCD (Charge Coupled Device), or the like. The capturing element 12 has an imaging surface on which a plurality of pixels are arranged. Each pixel outputs a signal specified by current or voltage according to an incident light quantity. The signal output by each pixel is also referred to as imaging data.

The imaging data of all pixels may be read out by the camera module 10 and captured by the controller 52 as a captured image. The captured image read out for all pixels is also referred to as a maximum captured image. The imaging data of some pixels may be read out by the camera module 10 and captured as a captured image. In other words, the imaging data may be read out from pixels in a predetermined capture range. The imaging data read out from pixels in the predetermined capture range may be captured as a captured image. The predetermined capture range may be set by the controller 52. The camera module 10 may acquire the predetermined capture range from the controller 52.

The capturing element 12 may capture an image of a predetermined capture range of the subject image formed through the imaging lens system 11.

Note that the present invention is not limited to the above-described examples, and they can be modified as appropriate without departing from the scope and spirit of the invention. For example, the use of the imaging lens system according to the present invention is not limited to on-board cameras and surveillance cameras, and instead can also be used for other uses such as cameras or the like used in small electronic apparatuses such as mobile phones.

This application is based upon and claims the benefit of priority from Japanese Patent Application No. 2022-004493, filed on Jan. 14, 2022, the disclosure of which is incorporated herein in its entirety by reference.

### INDUSTRIAL APPLICABILITY

It is possible to provide an imaging lens system, a camera module, an in-vehicle system, and a vehicle which have sufficient brightness with reduced cost.

### REFERENCE SIGNS LIST

10 CAMERA MODULE
11 IMAGING LENS SYSTEM
12 CAPTURING ELEMENT
40 CAR (VEHICLE)
42 INFORMATION PROCESSING APPARATUS (PROCESSING APPARATUS)
43 DISPLAY APPARATUS (OUTPUT APPARATUS)
50 CAPTURING APPARATUS
52 CONTROLLER
L1 FIRST LENS
L2 SECOND LENS
L3 THIRD LENS
L4 FOURTH LENS
L5 FIFTH LENS
L6 SIXTH LENS STOPIRIS
Gf FRONT LENS GROUP
Gr REAR LENS GROUP
IRCF INFRARED CUT FILTER
IMG FOCAL PLANE
OA OPTICAL AXIS

1. An imaging lens system comprising, sequentially from an object side toward an image side:
a first lens having positive power with an object-side surface whose convex surface faces the object side; a second lens having negative power with an object-side surface whose convex surface faces the object side; a third lens, the third lens being a meniscus lens having positive power with an image-side surface whose convex surface faces the image side; a fourth lens having negative power with an image-side surface whose concave surface faces the image side; a fifth lens which is a biconvex lens having positive power; and a sixth lens with an object-side surface whose convex surface faces the object side, wherein
the imaging lens system satisfies the following Conditional Expressions (1) to (3):
nd1>1.77 (1),
nd2>1.77 (2), and
0.8<f3/f<12.0 (3)
where nd1 is defined as a d-line refractive index of the first lens, nd2 is defined as a d-line refractive index of the second lens, f3 is defined as a focal length of the third lens, and f is defined as a focal length of an entire optical system.

2. The imaging lens system according to claim 1, wherein the imaging lens system satisfies the following Conditional Expression (4):
vd4<24 (4)
where vd4 is defined as an Abbe's number of the fourth lens.

3. The imaging lens system according to claim 1, wherein
the object-side surface and the image-side surface of the third lens have aspherical surface shapes, and
the object-side surface and the image-side surface of the sixth lens have aspherical surface shapes.

4. The imaging lens system according to claim 1, wherein the imaging lens system satisfies the following Conditional Expression (5):

|f6/f|>3.5 (5)
where f6 is defined as a focal length of the sixth lens.

5. The imaging lens system according to claim 1, wherein the imaging lens system satisfies the following Conditional Expression (6) in a range of 20° C. or higher and 40° C. or lower:
dNd5/dt(×10−6/° C.)<0 (6)
where dNd5/dt is defined as a temperature coefficient of a relative refractive index in a d-line of the fifth lens.

6. The imaging lens system according to claim 1, wherein an iris is arranged between the third lens and the fourth lens.

7. The imaging lens system according to claim 1, wherein the fourth lens and the fifth lens constitute a cemented lens.

8. The imaging lens system according to claim 1, wherein the imaging lens system satisfies the following Conditional Expression (7):
1.2<f45/f<2.2 (7)
where f45 is defined as a focal length of the cemented lens constituted of the fourth lens and the fifth lens.

9. A camera module comprising:
the imaging lens system according to claim 1; and
a capturing element configured to convert light condensed through the imaging lens system into an electrical signal.

10. An in-vehicle system mounted on a car comprising:
the camera module according to claim 9; and
an information processing apparatus configured to process a captured image output from the capturing element of the camera module and recognize an object in the captured image.

11. A vehicle on which the in-vehicle system according to claim 10 is mounted, further comprising an output apparatus configured to output information to an occupant, wherein the information processing apparatus is configured to output recognition information about the object to the output apparatus.
